(19) United States
(12) Patent Application Publication
(10) Pub. No.: US 2014/0279489 A1
(43) Pub. Date: Sep. 18, 2014

(54) SYSTEMS AND METHODS FOR PROVIDING ALTERNATIVE LOGINS FOR MOBILE BANKING

(71) Applicants: Tobias D. Russell, Alexandria, VA (US); Aaron G. Kirby, Richmond, VA (US); James Ashfield, Midlothian, VA (US); Joseph T. Riggs, Dallas, TX (US)

(72) Inventors: Tobias D. Russell, Alexandria, VA (US); Aaron G. Kirby, Richmond, VA (US); James Ashfield, Midlothian, VA (US); Joseph T. Riggs, Dallas, TX (US)

(73) Assignee: CAPITAL ONE FINANCIAL CORPORATION, McLean, VA (US)

(21) Appl. No.: 14/212,016

(22) Filed: Mar. 14, 2014

Related U.S. Application Data
(60) Provisional application No. 61/788,547, filed on Mar. 15, 2013.

(51) Int. Cl. G06Q 40/02; H04L 29/06

(52) U.S. Cl. CPC G06Q 40/02; H04L 63/083
USPC 705/42

(57) ABSTRACT

Systems and methods are disclosed for providing access and authentication scenarios for mobile, or remote, banking via a client device. A financial service provider system determines a desired level of security for various mobile banking transactions, and configures a unique login credential or attribute for each level or tier of security. After receiving an indication that a user desires to perform a mobile banking transaction, and determining the mobile banking transaction desired by the user, the financial service provider system prompts the user for the associated login credential or attribute. Finally, the system receives and validates the credential.

### CROSS-REFERENCE TO RELATED APPLICATIONS

This application claims priority under 35 U.S.C. §119 to U.S. Provisional Application No. 61/788,547, filed on Mar. 15, 2013, which is expressly incorporated herein by reference in its entirety.

### BACKGROUND

Consumers increasingly demand remote access to financial service accounts and other banking information. Mobile banking technology has advanced to the point that few transactions need to be conducted in a brick and mortar bank branch. Increasing the array of mobile banking options provides convenience to the consumer, and often to the bank as well, but it also creates significant security concerns. Mobile devices can easily be lost, stolen, or transmissions can be intercepted. While strong passwords remain effective security measures, they can be hacked, or more likely, simply mistyped or forgotten by the consumer. Accordingly, there is a need to provide alternative authentication methods for mobile banking systems to provide additional convenience, functionality, and security.

### SUMMARY

Methods, systems, and articles of manufacture described herein enable a computer system to provide secure remote banking services via one or more configured “login” scenarios that may be required at any stage of a transaction for authentication or access. In one embodiment, the computer system may assign classifications to mobile banking transactions based on the level of security required for each transaction. Additionally, the computer system may configure a login scenario for each of the assigned classifications. Further, the computer system may receive an indication that a user desires to perform a mobile banking transaction, and may determine the mobile banking transaction desired by the user. The computer system may also determine the assigned classification associated with the desired mobile banking transaction, and prompt the user for the configured authentication scenario associated with the assigned classification. Finally, the computer system may receive a login credential or attribute from the user.

In another embodiment, a method is disclosed for providing remote banking services. The method includes assigning classifications to mobile banking transactions based on the level of security required for each transaction. Additionally, the method includes configuring a login scenario for each of the assigned classifications. Further, the method includes receiving an indication that a user desires to perform a mobile banking transaction, and determining the mobile banking transaction desired by the user. The method also includes determining the assigned classification associated with the desired mobile banking transaction, and prompting the user for the configured login scenario associated with the assigned classification. Finally, the method includes receiving a login credential or attribute from the user.

In yet another embodiment, a computer system is disclosed for providing remote banking services. The computer system may receive an indication that a user desires to perform a mobile banking transaction, and determine the mobile banking transaction desired by the user. Additionally, the computer system may transmit an indication of the desired mobile banking transaction to a financial service provider system. Further, the computer system may receive information from the financial service provider system related to a login credential or attribute associated with the user and the desired mobile banking transaction. The computer system may prompt the user to input the required login credential or attribute, receive the login credential or attribute, and validate the login credential or attribute.

In yet another embodiment, a non-transitory computer-readable storage medium is disclosed, containing instructions which, when executed on or by a processor, perform a method for providing remote banking services. The method includes assigning classifications to mobile banking transactions based on the level of security required for each transaction. Additionally, the method includes configuring a login scenario for each of the assigned classifications. Further, the method includes receiving an indication that a user desires to perform a mobile banking transaction, and determining the mobile banking transaction desired by the user. The method also includes determining the assigned classification associated with the desired mobile banking transaction, and prompting the user for the configured login scenario associated with the assigned classification. Finally, the method includes receiving a login credential or attribute from the user.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary system, consistent with disclosed embodiments.

FIG. 2 is a block diagram of another exemplary system, consistent with disclosed embodiments.

FIG. 3 is a block diagram of another exemplary system, consistent with disclosed embodiments.

FIG. 4 is a flowchart of an exemplary mobile banking process, consistent with disclosed embodiments.

FIG. 5 is a flowchart of an exemplary mobile banking security initiation process, consistent with disclosed embodiments.

FIG. 6 is a flowchart of an exemplary mobile banking login process, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

The disclosed embodiments provide various alternative security options for mobile or online banking applications. Different banking transactions which can be performed remotely require multifactor authentication but at varying levels of strength. A transaction that does not involve overly sensitive information and is performed frequently, such as a balance check, a list of accounts without account numbers, a list of bank branches, etc. might need only a lower level of security, and the user experience can be improved by providing a rapid means of access. For more sensitive transactions, such as balance transfers, setting up automatic bill payments, etc., more security is required, and alternative, stronger forms of login credential or attributes (attributes in the sense of biometric scanning of DNA, behavior, or other inherent characteristics) can be configured and presented to the user. As used in this specification, a “login” credential or attribute refers to a credential required of and submitted by a user at any point throughout the mobile banking process. Different login credentials may be required at various points within the same mobile banking session.

FIG. 1 is a block diagram of an exemplary system 100 for performing one or more operations consistent with the disclosed embodiments. In one embodiment, system 100 may include one or more financial service provider systems 110, one or more clients devices 120, one or more bank systems 130, one or more mobile banking systems 150, and network 140. The components and arrangement of the components included in system 100 may vary. Thus, system 100 may include other components that perform or assist in the performance of one or more processes consistent with the disclosed embodiments.

Components of system 100 may be computing systems configured to provide secured mobile banking access consistent with disclosed embodiments. As used herein, “mobile” means remote. “Mobile” banking transactions may be performed on a variety of client devices, such as desktop computers, automated teller machines (ATMs), or dedicated kiosks that may or may not be actually mobile or portable. As further described herein, components of system 100 may include one or more computing devices (e.g., computer(s), server(s), etc.), memory storing data and/or software instructions (e.g., database(s), memory devices, etc.), and other known computing components. In some embodiments, the one or more computing devices are configured to execute software instructions stored on one or more memory devices to perform one or more operations consistent with the disclosed embodiments. Components of system 100 may be configured to communicate with one or more other components of system 100, including financial service provider system 110, client device 120, bank system 130, and/or mobile banking system 150. In certain aspects, users may operate one or more components of system 100 to initiate one or more operations consistent with the disclosed embodiments. In some aspects, the one or more users may be employees of, or associated with, the entity corresponding to the respective component(s) (e.g., someone authorized to use the underlying computing systems or otherwise act on behalf of the entity). In other aspects, the user may not be an employee or otherwise associated with underlying entity. In still other aspects, the user may itself be the entity associated with the respective component (e.g., user 122 operating client device 120).

Financial service provider system(s) 110 may be associated with an entity providing financial services. For example, financial service provider system 110 may be associated with a bank, credit card issuer, or other type of financial service entity that generates, provides, manages, and/or maintains financial service accounts for one or more users. Financial service accounts may include, for example, credit card accounts, loan accounts, checking accounts, savings accounts, reward or loyalty program accounts, and/or any other type of financial service account known to those skilled in the art. Financial service provider system 110 may include infrastructure and components that are configured to generate and/or provide financial service accounts such as credit card accounts, loan accounts, checking accounts, debit card accounts, loyalty or reward programs, lines of credit, and the like. Financial service provider system 110 may include functionality for communications with users such as user 122. In some embodiments, financial service provider system 110 may transmit messages to user 122 related to a financial account (for example, that an online statement is ready). Financial service system 110 may further possess the capability to issue or transmit alerts to user 122. In some embodiments, the alert may take the form of an iOS push message. The content of the alerts may comprise information such as fraud attempts, changes in account information, or other notifications triggered by predetermined criteria, preferences, or parameters.

Client device(s) 120 may include one or more processors configured to execute software instructions stored in memory, such as memory included in client device 120. Client device 120 may include software executable by a processor to perform Internet-related communication and content presentation processes. For instance, client device 120 may execute software that generates and displays interfaces and/or content on a presentation device included in, or connected to, client device 120. Client device 120 may be a mobile device that executes mobile device applications and/or mobile device communication software that allows client device 120 to communicate with components over network 140. The disclosed embodiments are not limited to any particular configuration of client device 120.

Bank system(s) 130 may be computing systems associated with entities that provide banking services and/or information such as a brick and mortar location of a financial institution, an investment firm, a brokerage firm, or any other type of entity that provides financial and banking goods, services, and/or information that consumers (i.e., end-users or other business entities) may purchase, consume, use, etc. Bank system(s) 130 is not limited to systems associated with merchant(s) that conduct business in any particular industry or field. Bank system(s) 130 may be the same entity as financial service provider system 110, or may operate as an independent entity.

Bank system 130 may be associated with a brick and mortar location(s) that a consumer (e.g., user 122) may physically visit and access or purchase goods and services. Such physical locations may include bank system 130, which may include computing devices that perform financial service transactions with consumers (e.g., ATM(s), kiosks, etc.). Bank system 130 may also include back- and/or front-end computing components that store data and execute software instructions to perform operations consistent with disclosed embodiments, such as computers that are operated by employees of the bank (e.g., back office systems, etc.). Bank system 130 may also be associated with entities that provide banking and/or financial services via known online or e-commerce type of solutions. Bank system 130 may include server(s) that are configured to execute stored software instructions to perform operations associated with a bank, including one or more processes associated with processing financial service accounts, evaluating and issuing lines of credit, providing investment packages, etc.

Mobile banking system 150 may be associated with entities that provide mobile banking services to users, banks, or other entities. In some embodiments, mobile banking system 150 may be a subsystem of financial service system 110, 210, as depicted in FIG. 2. Mobile banking system 150, however, is not limited to systems associated with entities that conduct business in any particular industry or field. In some embodiments, mobile banking system 150 may host or otherwise provide financial service accounts to one or more of consumers (such as users 122, 222), merchants, etc. In some embodiments, mobile banking system 150 may be a subsystem of bank system 130. In other embodiments, mobile banking system 150 may be an service provider for entities including financial service provider system 110 and bank system 130.

Network 140 may be any type of network configured to provide communications between components of system 100. For example, network 140 may be any type of network (including infrastructure) that provides communications, exchanges information, and/or facilitates the exchange of information, such as the Internet, a Local Area Network, or other suitable connection(s) that enables the sending and receiving of information between the components of system 100. In other embodiments, one or more components of system 100 may communicate directly through a dedicated communication link(s), such as links between financial service provider system 110, client device 120, bank system 130, and mobile banking system 150.

FIG. 2 is a block diagram of another exemplary system 200 for performing one or more operations consistent with the disclosed embodiments. In certain embodiments, financial service provider system 210 may include mobile banking system 150 and otherwise be configured to provide mobile banking access to client device 220 and user 222. Consistent with disclosed embodiments, financial service provider system 210 may use or otherwise communicate with computing devices of other elements of system 200 via computing elements (e.g., server 211). Furthermore, financial service provider 210 may access memory devices (not shown) to retrieve, for example, financial transaction data associated with a user 222. Financial service provider 210 may otherwise be configured and operate similar to financial service provider system 110 disclosed above in connection with FIG. 1. Similarly, client devices 220 and merchant systems 230 may be configured and operate similar to similarly labeled components disclosed above in connection with FIG. 1.

It is to be understood that the configuration and boundaries of the functional building blocks of systems 100 and 200 have been defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

FIG. 3 shows an exemplary system 300 for implementing embodiments consistent with the disclosed embodiments. Variations of exemplary system 300 may be used by financial service provider system 110, client devices 120, bank systems 130, and/or mobile banking system 150. In one embodiment, system 300 may include a server 311 having one or more processors 321, one or more memories 323, and one or more input/output (I/O) devices 322. Alternatively, server 311 may take the form of a mobile computing device, general purpose computer, a mainframe computer, or any combination of these components. According to some embodiments, server 311 may comprise web server(s) or similar computing devices that generate, maintain, and provide web site(s) consistent with disclosed embodiments. Server 311 may be standalone, or it may be part of a subsystem, which may be part of a larger system. For example, server 311 may represent distributed servers that are remotely located and communicate over a network (e.g., network 140) or a dedicated network, such as a LAN. Server 311 may correspond to server 211, or separately to any server or computing device included in financial service provider system 110, client devices 120, bank systems 130, and/or mobile banking system 150.

Processor 321 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in server 311.

Memory 323 may include one or more storage devices configured to store instructions used by processor 321 to perform functions related to disclosed embodiments. For example, memory 323 may be configured with one or more software instructions, such as program(s) 324 that may perform one or more operations when executed by processor 321. The disclosed embodiments are not limited to separate programs or computers configured to perform dedicated tasks. For example, memory 323 may include a single program 324 that performs the functions of the server 311, or program 324 could comprise multiple programs. Additionally, processor 321 may execute one or more programs located remotely from server 311. For example, financial service provider system 110, client devices 120, bank systems 130, and/or mobile banking system 150, may, via server 311, access one or more remote programs that, when executed, perform functions related to certain disclosed embodiments. Memory 323 may also store data 325 that may reflect any type of information in any format that the system may use to perform operations consistent with the disclosed embodiments.

I/O devices 322 may be one or more devices configured to allow data to be received and/or transmitted by server 311. I/O devices 322 may include one or more digital and/or analog communication devices that allow server 311 to communicate with other machines and devices, such as other components of systems 100 and 200.

Server 311 may also be communicatively connected to one or more database(s) 327 through network 140. Database 327 may include one or more memory devices that store information and are accessed and/or managed through server 311. By way of example, database(s) 327 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, system 300 may include database 327. Alternatively, database 327 may be located remotely from the system 300. Database 327 may include computing components (e.g., database management system, database server, etc.) configured to receive and process requests for data stored in memory devices of database(s) 327 and to provide data from database 327.

FIG. 4 shows a flowchart of an exemplary mobile banking process 400, consistent with disclosed embodiments. In certain embodiments, financial service provider system (e.g., system 110, 210), client devices (e.g. devices 120, 220) and/or bank system (130, 230) may execute software instructions to perform one or more aspects of the mobile banking process of FIG. 4. As an example, FIG. 4 is disclosed in connection with financial service provider system 210. FIG. 4 will be described in connection with financial service provider system 210 as the financial service account provider, but it is understood that other components may provide an account to user 222, such as bank systems (130, 230).

In one aspect, financial service provider system 210 may configure a financial service account for a user (e.g., user 122, 222) (Step 410). Configuring the account may include setting up a new account, or it may entail altering account parameters for an existing account. In some embodiments, financial service provider system 210 may collect account information for purposes of configuring a financial service account. Financial service provider system 210 may organize the account information into a profile for the financial account. The financial service account information may include the identity of the account provider, the identity of an account (e.g., account number(s), etc.), the identity of other accounts (e.g., one or more financial accounts may be associated with the user), and/or credentials that enable mobile banking system 150 to access, receive, and/or store information relating to the users account.

Financial service provider system 210 may configure mobile banking access for a financial service account configured for user 222 (Step 420). In some embodiments, financial service provider system 210 may authorize access to one or more financial service accounts associated with user 222 via client devices 220. The configuration step may include determining and deploying a user interface. In some embodiments, financial service provider system 210 may automatically provide mobile banking capability for users of financial service accounts. In other embodiments, user 222 may be required to affirmatively elect to configure mobile banking capability. In some aspects, configuring mobile banking capability may involve one or more network-enabled computing devices (e.g., one or more client devices 120, 220). According to some embodiments, the one or more client devices 120 may include one or more software programs for installation. The software program(s) may be an .exe file, a mobile app, a shared object (e.g., a Dynamic Link Library (DLL)), etc. Regardless of form, the software program may enable client device(s) 120, 220 to an interface and communicate interactions of a user (e.g., user 122, 222) to financial service provider system 210. In some embodiments, “mobile” banking may be accessed from a client device 120, 220 that is not “mobile” in the sense of the word, such as a desktop computer, an automated teller machine (ATM), or a kiosk configured for such a purpose. In some embodiments, mobile banking may be possible on a television, or on accessories worn on a user's person, such as an earpiece, eyewear, or an article of clothing.

Financial service provider system 210 may perform a mobile banking security initiation process, such as is disclosed below in connection with FIG. 5. In brief, according to some embodiments, financial service provider system 210 may assign various levels of security to different transactions that user 222 may perform via client devices 220. For each level of security, financial service provider system 210 may configure a unique set of login credential or attributes necessary for a mobile user to complete a transaction with that particular assigned level of security. In some embodiments, the type of security employed for each transaction may be selected by the user. In other embodiments, the type of security may be globally set by financial service provider system 210.

Next, financial service provider system 210 may receive an indication that user 222 desires to perform a mobile banking transaction (Step 440). Financial service provider system 210 may receive the indication via telephonic means, via a mobile app associated with one or more of financial service provider system 210 or bank system 230, via a text or SMS message, or by other wireless or wired means over network 240.

At Step 450, financial service provider system may determine the type of mobile banking transaction desired to be completed by user 222 via client devices 220. Possible mobile banking transactions may include viewing active financial service accounts, viewing details and information about the active financial service accounts, viewing transaction information associated with the active financial service accounts, paying credit card bills, paying loan payments, paying mortgage payments, configuring or canceling an automatic payment or series of payments, such as online bill payments, adding an external “pay from” account (which may be another financial service account or an electronic wallet account), changing parameters associated with the financial service account or the mobile banking account (i.e. name, address, contact information, mailing address, phone number, alerts that the customer is subscribed to, etc.), conducting balance transfers, managing rewards accounts, reporting fraudulent transactions or suspicious activity (such as phishing text messages), communicating with financial service system or bank system employees (via online chat, video chat, a mobile application, etc.), adding a payee for bill payments, adding new destination accounts for transfers, using a banking login credential or attribute for access to an unrelated service (such as OAUTH or federated identity/authentication) and conducting high dollar transfers of funds.

Financial service provider system 210 may perform a mobile banking login process (Step 460), such as is disclosed below in connection with FIG. 6. In brief, depending on the type(s) of mobile banking transactions that user 222 desires to execute, different alternative forms of login may be configured and utilized. After receiving proper login credentials or attributes, financial service provider system 210 performs the desired mobile banking transaction (Step 470).

FIG. 5 shows a flowchart of an exemplary mobile banking security initiation process 500, consistent with disclosed embodiments and Step 430 of mobile banking process 400 as illustrated in FIG. 4. In certain embodiments, financial service provider system (e.g., system 110, 210), client devices (e.g. devices 120, 220) and/or bank system (130, 230) may execute software instructions to perform the tipping information compilation process of FIG. 5. As an example, FIG. 5 is disclosed in connection with financial service provider system 210.

At Step 510, financial service provider system 210 may assign mobile banking transactions to various “tiers” or levels of security. According to some embodiments, low-risk/high-volume transactions that would be commonly performed on a regular basis by user 222 may be assigned to lower security tiers. In other embodiments, higher risk/lower volume transactions may be assigned to higher tiers. In the example illustrated in FIG. 5, there are four tiers of security, with “tier 1” comprising the lowest level of security, and “tier 4” comprising the highest level of security.

Transactions at the tier 1 level may include, as non-limiting examples, low-level transactions such as viewing ATM locations, viewing bank branch locations or other identifying information associated with financial service provider system 210 and/or bank system 230, etc.

Transactions at the tier 2 level may include, as non-limiting examples, viewing active financial service accounts, viewing details and information about the active financial service accounts, viewing transaction information associated with the active financial service accounts, paying credit card bills, paying loan payments, paying mortgage payments, configuring or canceling an automatic payment or series of payments, such as online bill payments, adding an external “pay from” account, etc.

Transactions at the tier 3 level may include, as non-limiting examples, changing mobile banking account parameters such as name, address, phone number, email address, changing passwords, changing security settings, etc.

Transactions at the tier 4 level may include, as non-limiting examples, conducting balance transfers, managing rewards accounts, adding a payee for bill payments, adding new destination accounts for transfers, conducting high dollar transfers of funds. These designations are intended to serve as merely illustrative examples, and transactions may be grouped in any number of tiers under various predetermined criteria.

According to example embodiments, financial service provider system 210 may configure various login scenarios for each of the security tiers. Users may be required to provide increasingly complex and unique credentials to access higher tiers of security. Financial service provider system 210 may configure a login scenario to be used when an indication is received that user 222 desires to perform a mobile banking transaction designated as security tier 1 (Step 520). In the example illustrated in FIG. 5, the login scenario may be a stored username that user 222 must complete and/or confirm in order to gain access to the mobile banking system. In other embodiments, other low-level login scenarios may be employed. In one embodiment, the login scenario for tier 1 transactions may comprise a directional swipe in a predetermined direction across a touch screen display. In some embodiments, financial service provider system 210 may provide additional layered controls, including but not limited to device risk analysis, localization of client devices 220 via IP address or GPS, logging of abnormal login attempts, and remote blocking or locking of client device 220 if certain predetermined conditions are met.

Financial service provider system 210 may configure a login scenario to be used when an indication is received that user 222 desires to perform a mobile banking transaction designated as security tier 2 (Step 530). In the example illustrated in FIG. 5, the login scenario may be a security “pattern” that user 222 must complete and/or confirm in order to gain access to the mobile banking system. The pattern may be preloaded into client device 220, or user 222 may be prompted to generate a unique pattern when mobile banking access is configured. The pattern may be presented to the user as part of a graphical user interface displayed on client device 220. A security pattern permits user 222 a quick login method for accessing low risk and high volume activities. In some embodiments, financial service provider system 210 may require user 222 to enter the same pattern two or more times to provide additional security. In some embodiments, the graphical user interface of client device 220 may indicate the relative “strength,” or complexity, of the security pattern at the time the pattern is initiated, either by user 222 or by financial service provider system 210. In other embodiments, other login scenarios may be employed for tier 2 security transactions. In some embodiments, financial service provider system 210 may provide additional layered controls, including but not limited to device risk analysis, localization of client devices 220 via IP address or GPS, logging of abnormal login attempts, and remote blocking or locking of client device 220 if certain predetermined conditions are met.

Financial service provider system 210 may configure a login scenario to be used when an indication is received that user 222 desires to perform a mobile banking transaction designated as security tier 3 (Step 540). In the example illustrated in FIG. 5, the login scenario may be a password that user 222 must complete and/or confirm in order to gain access to the mobile banking system. The password may be preloaded into client device 220, or user 222 may be prompted to generate a unique password when mobile banking access is configured. In some embodiments, financial service provider system 210 may require user 222 to enter the same password two or more times to provide additional security. In some embodiments, the graphical user interface of client device 220 may indicate the relative “strength,” or complexity, of the password at the time the password is initiated, either by user 222 or by financial service provider system 210. Financial service provider system 210 may impose conditions for the password, such as a minimum and/or maximum number of characters, presence of capital letters, and/or presence of diacritical or punctuation marks. In other embodiments, other login scenarios may be employed for tier 3 security transactions. In some embodiments, financial service provider system 210 may provide additional layered controls, including but not limited to device risk analysis, localization of client devices 220 via IP address or GPS, logging of abnormal login attempts, remote blocking or locking of client device 220 if certain predetermined conditions are met, and at this higher level of security, additional transaction monitoring services, alerts, and policy controls.

Financial service provider system 210 may configure a login scenario to be used when an indication is received that user 222 desires to perform a mobile banking transaction designated as security tier 4, the highest level (Step 550). In the example illustrated in FIG. 5, the login scenario may be biometric facial recognition that user 222 must complete and/or confirm in order to gain access to the mobile banking system. Financial service provider system 210 may prompt user 222 to take a facial photograph for purposes of facial recognition when mobile banking access is initially configured. In some embodiments, each time user 222 desires to conduct a tier 4 transaction, financial service provider system 210 may prompt user 222 to take a photograph via client device 220. In other embodiments, facial recognition may be achieved via client device 220 by means other than taking a photograph, such as a mobile application that utilizes a camera lens associated with client device 220 but does not acquire a permanent image. Financial service provider system 210 may derive parameters associated with the face of user 222 from the initial photograph, such as facial size, arrangement of facial features, etc., and may use said parameters in the facial recognition. In some embodiments, financial service provider system 210 may configure the facial recognition functionality such that motion can be detected, such as by capturing multiple images or taking video. In these examples, blinking, facial motion, and other unique characteristics can be evaluated by the facial recognition system and integrated into the login credential. Facial recognition provides a high, almost unparalleled level of security, while also being easy for user 222 to use, since facial features cannot be forgotten and cannot be mistyped, like a password or a pattern. In some embodiments, financial service provider system 210 may require user 222 to undergo facial recognition two or more times to provide additional security. In some embodiments, financial service provider system 210 may configure the facial recognition functionality in a manner such that it is not a means of login or basic access, but rather a means to increase the security level for certain transactions or activities in the middle of a mobile banking session. In alternative embodiments, other login scenarios may be employed for tier 4 security transactions. In some embodiments, user 222 may utilized voice recognition, which may be based on a microphone function in client device 220. In other embodiments, user 222 may be called by an employee affiliated with financial service provider system 210 and/or bank system 230 to confirm their identity. In other embodiments, other types of unique biometric recognition may be implemented into the login scenario, such as fingerprints, retina scans, finger pressure, etc. Client device 220 may be configured to accept various biometric logins via modules and software programs. In some embodiments, financial service provider system 210 may provide additional layered controls, including but not limited to device risk analysis, localization of client devices 220 via IP address or GPS, logging of abnormal login attempts, remote blocking or locking of client device 220 if certain predetermined conditions are met, and at this higher level of security, additional transaction monitoring services, alerts, and policy controls.

In some embodiments, user 222 may configure one of the authentication methods as a default. As an example, user 222 may set entry of a security pattern as the default (for example pattern for log in with facial recognition for step up authentication for high risk activities, or configure facial recognition for log in thereby removing need for any further step up authentication

FIG. 6 shows a flowchart of an exemplary mobile banking login process 600, consistent with disclosed embodiments and with Step 460 of mobile banking process 400 as illustrated in FIG. 4. In certain embodiments, financial service provider system (e.g., system 110, 210), client devices (e.g. devices 120, 220) and/or bank system (130, 230) may execute software instructions to perform the user tipping data determination process of FIG. 6. As an example, FIG. 6 is disclosed in connection with financial service provider system 210.

At Step 610, financial service provider system 210 determines whether user 222 desires to conduct a security tier 1 mobile banking transaction. If user 222 does wish to conduct a tier 1 transaction (Step 610: YES), financial service provider system 210 may perform the previously configured login scenario associated with security tier 1 and verify that the user has provisioned the proper credential (Step 612). In the example illustrated in FIG. 6, the login scenario for tier 1 is completion and/or confirmation of a saved username. If user 222 successfully completes the username (Step 614: YES), access is allowed to the mobile banking system (Step 616). If user 222 does not successfully complete the username (Step 614: NO), the process proceeds to Step 650, and access to the mobile banking system is denied.

If user 222 does not desire to conduct a tier 1 transaction (Step 610: NO), financial service provider system 210 determines whether user 222 instead desires to conduct a tier 2 transaction (Step 620). If user 222 does wish to conduct a tier 2 transaction (Step 620: YES), financial service provider system 210 prompts user 222 for the previously configured login scenario associated with security tier 2 (Step 622). In the example illustrated in FIG. 6, the login scenario for tier 2 is completion and/or confirmation of a security pattern. If user 222 successfully completes the security pattern login (Step 624: YES), access is allowed to the mobile banking system (Step 626). If user 222 does not successfully complete the username (Step 624: NO), the process proceeds to Step 650, and access to the mobile banking system is denied.

If user 222 does not desire to conduct a tier 2 transaction (Step 620: NO), financial service provider system 210 determines whether user 222 instead desires to conduct a tier 3 transaction (Step 630). If user 222 does wish to conduct a tier 3 transaction (Step 630: YES), financial service provider system 210 prompts user 222 for the previously configured login scenario associated with security tier 3 (Step 632). In the example illustrated in FIG. 6, the login scenario for tier 3 is completion and/or confirmation of a password. If user 222 successfully completes the password login (Step 634: YES), access is allowed to the mobile banking system (Step 636). If user 222 does not successfully complete the username (Step 634: NO), the process proceeds to Step 650, and access to the mobile banking system is denied.

If user 222 does not desire to conduct a tier 3 transaction (Step 630: NO), financial service provider system 210 determines whether user 222 instead desires to conduct a tier 4 transaction (Step 640). If user 222 does wish to conduct a tier 4 transaction (Step 640: YES), financial service provider system 210 prompts user 222 for the previously configured login scenario associated with security tier 4 (Step 642). In the example illustrated in FIG. 6, the login scenario for tier 4 is biometric facial recognition. If user 222 successfully verifies their identity through facial recognition (Step 644: YES), access is allowed to the mobile banking system (Step 646). If user 222 does not successfully complete the username (Step 644: NO), the process proceeds to Step 650, and access to the mobile banking system is denied.

If user 222 also does not want to conduct a tier 4 transaction (Step 640: NO), access is denied to the mobile banking system as the user may be attempting to conduct a transaction that is not supported or permitted by the mobile banking system (Step 650). The examples illustrated in FIG. 6 are not intended to be limiting. As an example, user 222 may configure a desired alternative login credential or attribute as defaults for various tiers. In some embodiments, the tiers may overlap. As an example, user 222 may configure the system such that a security pattern is used for all logins to access transactions and activities associated with tiers 1, 2, and 3, and then facial recognition for activities requiring higher levels of security such as tier 4. Mobile banking login process 600 may be implemented and conducted with various numbers of security tiers, and various alternative login scenarios associated with the various tiers. In some embodiments, user 222 may wish to conduct multiple transactions during a single mobile banking session that are associated with different assigned tiers of security. In some embodiments, if the additional transaction(s) desired by user 222 are of a lower assigned tier of security, user 222 may remain logged in to the mobile banking system and immediately perform the additional transaction(s). In other embodiments, if the additional transaction(s) desired by user 222 are of a higher assigned tier of security, user 222 may be sent back to the login screen and be prompted to enter the set of alternative login credentials or attributes that have been configured for the user's account at that particular assigned tier of security.

In some embodiments, activity of user 222 detected by financial service provider system 210 on other devices may lead financial service provider system 210 to initiate a mobile banking session via client device 220. As an example, financial service provider system 210 may detect or receive an indication that user 222 is attempting to complete a transaction or activity on an ATM, desktop computer, or other device that requires higher security or verification of identity. Financial service provider system 220 may then prompt the user to verify identity via a biometric credential, such as facial recognition, retinal scanning, or fingerprints.

In some embodiments, the systems described herein may be configured to have increased accessibility for users with disabilities. As an example, the pattern login alternative, described above in the example of FIG. 6 as being associated with security tier 2, may be implemented in a manner such that users who are visually impaired may be able to orient on the touchscreen of the client device using audio cues. Further, as the pattern is entered, audio tones may help assist such users in entering the pattern. In other embodiments, the facial recognition system, described above in the example of FIG. 6 as being associated with security tier 4, may also be configured in a similar manner. As an example, the system may provide audio cues to a visually impaired user to tell them that their face is within the detection range of the client device, and may also provide audio cues indicating that the image capture process is underway, and then completed.

Other embodiments will be apparent to those skilled in the art from consideration of the specification and practice of the disclosed embodiments. It is intended that the specification and examples be considered as exemplary only, with a true scope and spirit of the disclosed embodiments being indicated by the following claims. Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

What is claimed is:

1. A system for providing remote banking services, comprising:
a memory storing instructions; and
a processor configured to execute the instructions to:
assign classifications to mobile banking transactions based on the level of security required for each transaction;
configure a login scenario for each of the assigned classifications;
receive an indication that a user desires to perform a mobile banking transaction;
determine the mobile banking transaction desired by the user;
determine the assigned classification associated with the desired mobile banking transaction;
prompt the user for the configured login scenario associated with the assigned classification; and
receive a login credential or attribute from the user.

2. The system of claim 1, wherein the one or more processors are further configured to:
determine whether the received login credential or attribute is valid.

3. The system of claim 2, wherein the one or more processors are further configured to:
confirm that the received login credential or attribute is valid; and
permit the user to access a mobile banking system based at least on the confirmation.

4. The system of claim 2, wherein the one or more processors are further configured to:
confirm that the received login credential or attribute is invalid; and
deny the user access to a mobile banking system based at least on the confirmation.

5. The system of claim 1, wherein the login scenario comprises validating a login credential comprising a predetermined username associated with the mobile banking system.

6. The system of claim 1, wherein the login scenario comprises validating a login credential comprising a predetermined pattern displayed as a graphical user interface on an electronic device.

7. The system of claim 1, wherein the login scenario comprises validating a login credential comprising a predetermined password associated with the mobile banking system.

8. The system of claim 1, wherein the login scenario comprises a login credential comprising a biometric recognition process.

9. The system of claim 8, wherein the biometric recognition process comprises facial recognition.

10. A method for providing remote banking services, comprising:
assigning classifications to mobile banking transactions based on the level of security required for each transaction;
configuring a login scenario for each of the assigned classifications;
receiving an indication that a user desires to perform a mobile banking transaction;
determining the mobile banking transaction desired by the user;
determining the assigned classification associated with the desired mobile banking transaction;
prompting the user for the configured login scenario associated with the assigned classification; and
receiving a login credential or attribute from the user.

11. The method of claim 10, further comprising:
determining whether the received login credential or attribute is valid.

12. The method of claim 11, further comprising:
confirming that the received login credential or attribute is valid; and
permitting the user to access a mobile banking system based at least on the confirmation.

13. The method of claim 11, further comprising:
confirming that the received login credential or attribute is invalid; and
denying the user access to a mobile banking system based at least on the confirmation.

14. The method of claim 10, wherein the login scenario comprises validating a login credential comprising a predetermined username associated with the mobile banking system.

15. The method of claim 10, wherein the login scenario comprises validating a login credential comprising a predetermined pattern displayed as a graphical user interface on an electronic device.

16. The method of claim 10, wherein the login scenario comprises validating a login credential comprising a predetermined password associated with the mobile banking system.

17. The method of claim 10, wherein the login scenario comprises a login credential comprising a biometric recognition process.

18. The method of claim 17, wherein the biometric recognition process comprises facial recognition.

19. A system for providing remote banking services, comprising:
a memory storing instructions; and
a processor configured to execute the instructions to:
receive an indication that a user desires to perform a mobile banking transaction;
determine the mobile banking transaction desired by the user;
transmit information associated with the desired mobile banking transaction to a financial service provider system;
receive information from the financial service provider system related to a login credential or attribute associated with the user and the desired mobile banking transaction;
prompt the user to input the required login credential or attribute;
receive the login credential or attribute; and
validate the login credential or attribute.

20. A non-transitory computer-readable storage medium containing instructions which, when executed on a processor, perform a method comprising:
assigning classifications to mobile banking transactions based on the level of security required for each transaction;
configuring a login scenario for each of the assigned classifications;
receiving an indication that a user desires to perform a mobile banking transaction;
determining the mobile banking transaction desired by the user;
determining the assigned classification associated with the desired mobile banking transaction;
prompting the user for the configured login scenario associated with the assigned classification; and
receiving a login credential or attribute from the user.
